(19) United States
(12) Patent Application Publication
(10) Pub. No.: US 2014/0351117 A1
(43) Pub. Date: Nov. 27, 2014

(54) SYSTEM FOR EXCHANGING BUSINESS SERVICES

(71) Applicant: Hao Tran, Regina (CA)

(72) Inventor: Hao Tran, Regina (CA)

(21) Appl. No.: 14/355,501

(22) PCT Filed: Dec. 14, 2011
(86) PCT No.: PCT/CA2011/001362

§ 371 Date: Aug. 8, 2014

(30) Foreign Application Priority Data
Nov. 7, 2011 (CA) 2757141

(51) Int. Cl. G06Q 20/24; G06F 3/0484; H04L 29/08; G06Q 30/02

(52) U.S. Cl. CPC G06Q 20/24; G06Q 30/0277; G06Q 40/02; G06F 3/04842; H04L 67/10
USPC 705/39

(57) ABSTRACT

The present invention seeks to provide methods and systems for the online exchange of business services between merchants, wherein credit is approved and used to establish virtual value recognition documents such as gift cards or coupons and acquire gift cards or coupons of other merchants. The website owner can generate revenue by retaining a percentage of the gift cards or coupons and reselling them to non-merchant users at a discount to the gift card face value.

### FIELD OF THE INVENTION

The present invention relates to the fields of computer systems and methods of facilitating online business transactions. More particularly, the present invention relates to an online system and method for facilitating the exchange of business services between merchants.

### BACKGROUND OF THE INVENTION

It is known in the field of online business transactions to register users in an interactive environment and facilitate the acquisition and exchange of business services between the users. Such systems generally require a user to pay a membership fee, and each transaction facilitated by the system normally requires an additional fee payment by the user (either the service acquirer or the service provider). Such fees form the revenue required by the website owner to continue its business operation.

While such prior art systems are generally well received and patronized, the requirement for membership fees and per-transaction fees can serve to deter participation in the system by users who have valuable services to offer but find the fees unreasonable or otherwise undesirable. Services exchange or barter systems are primarily intended to avoid the exchange of funds, and hence a system that is grounded in fee payments stands in opposition to the foundational rationale.

What is needed, therefore, is a method and system that can facilitate the online exchange of business services without requiring membership or per-transaction fee payments.

### SUMMARY OF THE INVENTION

The present invention therefore seeks to provide a system and method for enabling merchants to advertise their services in an online environment and acquire the services of other merchants without the requirement of a fee-based approach.

According to a first aspect of the present invention there is provided a computer-implemented method for facilitating exchange of services between a plurality of users, the method comprising the steps of:
a. providing a computer system connected to a communication network;
b. providing an online environment accessible through a user interface of the computer system via the communication network;
c. allowing the plurality of users to access the online environment;
d. allowing first and second users of the plurality of users to create accounts in the online environment;
e. receiving a credit request from each of the first and second users;
f. updating the accounts to reflect an approved credit level for each of the first and second users;
g. allowing the first user to create and upload to the online environment at least one first-user virtual value recognition document for services to be provided by the first user, the at least one first-user virtual value recognition document being assigned a first value equal to or less than the approved credit level of the first user;
h. allowing the second user to search for and locate the at least one first-user virtual value recognition document;
i. allowing the second user to select the at least one first-user virtual value recognition document and acquire it by exchanging a first credit amount from the approved credit level of the second user equivalent to the first value;
j. decreasing the approved credit level of the second user by the first credit amount; and
k. allowing the second user to save or print the at least one first-user virtual value recognition document.

According to a second aspect of the present invention there is provided a method for electronically exchanging services, the method comprising the steps of:
a. providing a computer system connected to a communication network;
b. providing an online environment accessible through a user interface of the computer system via the communication network;
c. allowing the plurality of users to access the online environment;
d. allowing first and second users of the plurality of users to create accounts in the online environment;
e. receiving a credit request from each of the first and second users;
f. updating the accounts to reflect an approved credit level for each of the first and second users;
g. allowing the first user to create and upload to the online environment at least one first-user virtual value recognition document for services to be provided by the first user, the at least one first-user virtual value recognition document being assigned a first value equal to or less than the approved credit level of the first user;
h. allowing the second user to search for and locate the at least one first-user virtual value recognition document;
i. allowing the second user to select the at least one first-user virtual value recognition document and acquire it by exchanging a first credit amount from the approved credit level of the second user equivalent to the first value;
j. decreasing the approved credit level of the second user by the first credit amount; and
k. allowing the second user to save or print the at least one first-user virtual value recognition document.

According to a third aspect of the present invention there is provided a computer-readable medium containing statements and instructions for facilitating exchange of services between a plurality of users, the computer-readable medium for installation within a computer system connected to a communication network, the computer system comprising a user interface providing access to an online environment through the communication network, the statements and instructions, when executed, causing the computer to perform a method comprising the steps of:
a. allowing the plurality of users to access the online environment;
b. allowing first and second users of the plurality of users to create accounts in the online environment;
c. receiving a credit request from each of the first and second users;
d. updating the accounts to reflect an approved credit level for each of the first and second users;
e. allowing the first user to create and upload to the online environment at least one first-user virtual value recognition document for services to be provided by the first user, the at least one first-user virtual value recognition document being assigned a first value equal to or less than the approved credit level of the first user;
f. allowing the second user to search for and locate the at least one first-user virtual value recognition document;
g. allowing the second user to select the at least one first-user virtual value recognition document and acquire it by exchanging a first credit amount from the approved credit level of the second user equivalent to the first value;
h. decreasing the approved credit level of the second user by the first credit amount; and
i. allowing the second user to save or print the at least one first-user virtual value recognition document.

According to a fourth aspect of the present invention there is provided a computer system within a networked environment for facilitating exchange of services between a plurality of users, comprising:
a user interface;
a memory storage device;
a processor coupled to the memory storage device and in communication with the user interface, the processor being operative to:
a. allow first and second users of the plurality of users to create accounts in the networked environment through the user interface;
b. save the accounts on the memory storage device;
c. receive a credit request from each of the first and second users through the user interface;
d. update the accounts to reflect an approved credit level for each of the first and second users;
e. allow the first user through the user interface to create at least one first-user virtual value recognition document for services to be provided by the first user, the at least one first-user virtual value recognition document being assigned a first value equal to or less than the approved credit level of the first user;
f. save the at least one first-user virtual value recognition document on the memory storage device;
g. allow the second user to search for and locate the at least one first-user virtual value recognition document through the user interface;
h. allow the second user through the user interface to select the at least one first-user virtual value recognition document and acquire it by exchanging a first credit amount from the approved credit level of the second user equivalent to the first value;
i. decrease the approved credit level of the second user by the first credit amount; and
j. allow the second user to save or print the at least one first-user virtual value recognition document.

According to a fifth aspect of the present invention there is provided a system within a networked environment for electronically exchanging services between a plurality of users, comprising:
means for allowing the plurality of users to create accounts;
means for receiving and approving credit requests from the plurality of users;
means for allowing the plurality of users to create virtual value recognition documents;
means for allowing a second user to search for and locate a first-user virtual value recognition document created by a first user having a first value;
means for allowing the second user to select the first-user virtual value recognition document and acquire it by exchanging a first credit amount from the approved credit level of the second user equivalent to the first value;
means for decreasing the approved credit level of the second user by the first credit amount; and
means for allowing the second user to save or print the first-user virtual value recognition document.

According to a sixth aspect of the present invention there is provided a system for facilitating electronic exchange of services between a plurality of users, comprising:
means for allowing the plurality of users to access a networked environment;
means for allowing the plurality of users to create accounts;
means for receiving and approving credit requests from the plurality of users;
means for allowing the plurality of users to create virtual value recognition documents;
means for allowing a second user to search for and locate a first-user virtual value recognition document created by a first user having a first value;
means for allowing the second user to select the first-user virtual value recognition document and acquire it by exchanging a first credit amount from the approved credit level of the second user equivalent to the first value;
means for decreasing the approved credit level of the second user by the first credit amount; and
means for allowing the second user to save or print the first-user virtual value recognition document.

According to a seventh aspect of the present invention there is provided a computer-implemented method of online networking based on exchange of business services between a plurality of users, comprising the steps of:
a. providing a computer system connected to a communication network;
b. providing an online environment accessible through a user interface of the computer system via the communication network;
c. allowing the plurality of users to access the online environment;
d. allowing first and second users of the plurality of users to create accounts in the online environment;
e. receiving a credit request from each of the first and second users;
f. updating the accounts to reflect an approved credit level for each of the first and second users;
g. allowing the first user to create and upload to the online environment at least one first-user virtual value recognition document for services to be provided by the first user, the at least one first-user virtual value recognition document being assigned a first value equal to or less than the approved credit level of the first user;
h. allowing the second user to search for and locate the at least one first-user virtual value recognition document;
i. allowing the second user to select the at least one first-user virtual value recognition document and acquire it by exchanging a first credit amount from the approved credit level of the second user equivalent to the first value;
j. decreasing the approved credit level of the second user by the first credit amount; and
k. allowing the second user to save or print the at least one first-user virtual value recognition document.

According to an eighth aspect of the present invention there is provided a computer-implemented system for online networking based on exchange of business services between a plurality of users, comprising:
a user interface;
a memory storage device;
a processor coupled to the memory storage device and in communication with the user interface, the processor being operative to:
a. allow first and second users of the plurality of users to create accounts in a networked environment through the user interface;
b. save the accounts on the memory storage device;
c. receive a credit request from each of the first and second users through the user interface;
d. update the accounts to reflect an approved credit level for each of the first and second users;
e. allow the first user through the user interface to create at least one first-user virtual value recognition document for services to be provided by the first user, the at least one first-user virtual value recognition document being assigned a first value equal to or less than the approved credit level of the first user;
f. save the at least one first-user virtual value recognition document on the memory storage device;
g. allow the second user to search for and locate the at least one first-user virtual value recognition document through the user interface;
h. allow the second user through the user interface to select the at least one first-user virtual value recognition document and acquire it by exchanging a first credit amount from the approved credit level of the second user equivalent to the first value;
i. decrease the approved credit level of the second user by the first credit amount; and
j. allow the second user to save or print the at least one first-user virtual value recognition document.

According to a ninth aspect of the present invention there is provided a computer program product comprising computer-executable instructions embodied in a non-transitory computer-readable medium, wherein said computer program product comprises a plurality of computer-parsable codes for causing a computer to perform a method comprising the steps of:
a. allowing the plurality of users to access the online environment;
b. allowing first and second users of the plurality of users to create accounts in the online environment;
c. receiving a credit request from each of the first and second users;
d. updating the accounts to reflect an approved credit level for each of the first and second users;
e. allowing the first user to create and upload to the online environment at least one first-user virtual value recognition document for services to be provided by the first user, the at least one first-user virtual value recognition document being assigned a first value equal to or less than the approved credit level of the first user;
f. allowing the second user to search for and locate the at least one first-user virtual value recognition document;
g. allowing the second user to select the at least one first-user virtual value recognition document and acquire it by exchanging a first credit amount from the approved credit level of the second user equivalent to the first value;
h. decreasing the approved credit level of the second user by the first credit amount; and
i. allowing the second user to save or print the at least one first-user virtual value recognition document.

In exemplary embodiments of the present invention, the second user is also allowed to create and upload to the online or networked environment at least one second-user virtual value recognition document for services to be provided by the second user, the at least one second-user virtual value recognition document being assigned a second value equal to or less than the approved credit level of the second user; the first user is then allowed to search for and locate the at least one second-user virtual value recognition document, and the first user is allowed to select the at least one second-user virtual value recognition document and acquire it by exchanging a second credit amount from the approved credit level of the first user equivalent to the second value; the approved credit level of the first user is decreased by the second credit amount, and the first user is allowed to save or print the at least one second-user virtual value recognition document.

In further exemplary embodiments of the present invention, wherein the first user creates and uploads to the online or networked environment at least two first-user virtual value recognition documents, the following additional steps may be present: providing an area of the online or networked environment accessible by non-user outside consumers; locating one of the at least two first-user virtual value recognition documents in the area of the online or networked environment accessible by non-user outside consumers; allowing a non-user outside consumer to access the online or networked environment; allowing the non-user outside consumer to search for and locate the one of the at least two first-user virtual value recognition documents; allowing the non-user outside consumer to select the one of the at least two first-user virtual value recognition documents and acquire it at a discount to the first value by providing payment information; authorizing the payment information; and allowing the non-user outside consumer to save or print the one of the at least two first-user virtual value recognition documents.

A detailed description of an exemplary embodiment of the present invention is given in the following. It is to be understood, however, that the invention is not to be construed as being limited to this embodiment.

### BRIEF DESCRIPTION OF THE DRAWINGS

In the accompanying drawings, which illustrate an exemplary embodiment of the present invention:

FIG. 1a is a flowchart illustrating one embodiment of a method in accordance with the present invention;

FIG. 1b is a flowchart illustrating one embodiment of a method in accordance with the present invention;

FIG. 1c is a flowchart illustrating one embodiment of a method in accordance with the present invention;

FIG. 2 is a block diagram of an exemplary networked system for use in implementing methods and systems consistent with exemplary embodiments of the present invention; FIG. 3a is a flowchart illustrating one embodiment of a merchant transaction in accordance with the present invention;

FIG. 3b is a flowchart illustrating one embodiment of a merchant transaction in accordance with the present invention;

FIG. 3c is a flowchart illustrating one embodiment of a merchant transaction in accordance with the present invention;

FIG. 4 is a flowchart illustrating one embodiment of an administrative module for a system in accordance with the present invention;

FIG. 5a is a screen shot illustrating a display list of currencies added within the global settings;

FIG. 5b is a screen shot illustrating a display list of countries and cities added within the global settings;

FIG. 5c is a screen shot illustrating a display list of percentages by merchant added within the global settings;

FIG. 5d is a screen shot illustrating a display list of denominations added within the global settings;

FIG. 5e is a screen shot illustrating a display list of categories added within the global settings;

FIG. 6a is a screen shot illustrating an interface within the user manager module for creating user roles;

FIG. 6b is a screen shot illustrating an interface within the user manager module for creating a user within the system;

FIG. 7a is a screen shot illustrating an interface within the merchant manager module for creating a merchant within the system;

FIG. 7b is a screen shot illustrating an interface within the merchant manager module for creating a merchant request;

FIG. 8a is a screen shot illustrating an interface within the gift card manager module for creating a gift card;

FIG. 8b is a screen shot illustrating an interface within the gift card manager module for entering data for a gift card;

FIG. 8c is a screen shot illustrating an interface within the gift card manager module for redeeming a gift card;

FIG. 8d is a screen shot illustrating a display list of redeemed gift cards;

FIG. 9a is a screen shot within the statistics module illustrating a list of redeemed gift cards;

FIG. 9b is a screen shot within the statistics module illustrating a list of purchased gift cards;

FIG. 10a is a screen shot illustrating a gift card display for merchant consideration;

FIG. 10b is a screen shot illustrating a detailed gift card display for merchant consideration; and

FIG. 10c is a screen shot illustrating a merchant cart display.

A preferred embodiment of the present invention will now be described with reference to the accompanying drawings.

### DETAILED DESCRIPTION OF THE INVENTION

Referring now in detail to the accompanying drawings, an embodiment of the present invention is illustrated. The present invention is directed to a method and system for facilitating a business services exchange in an online or networked environment without the requirement of fee payments to the website owner. In the exemplary embodiment described herein, at no time in the process is the user required to pay any fees to either the website owner of any other user, and the method and system will allow the user to create the value recognition document in any desired denomination, for example as little as $5 in value per transaction. Note that, while a “gift card” or coupon format is the preferred form of value recognition document described below, other document forms common in similar transactions are equally applicable and intended to be included within the scope of the present invention.

Method

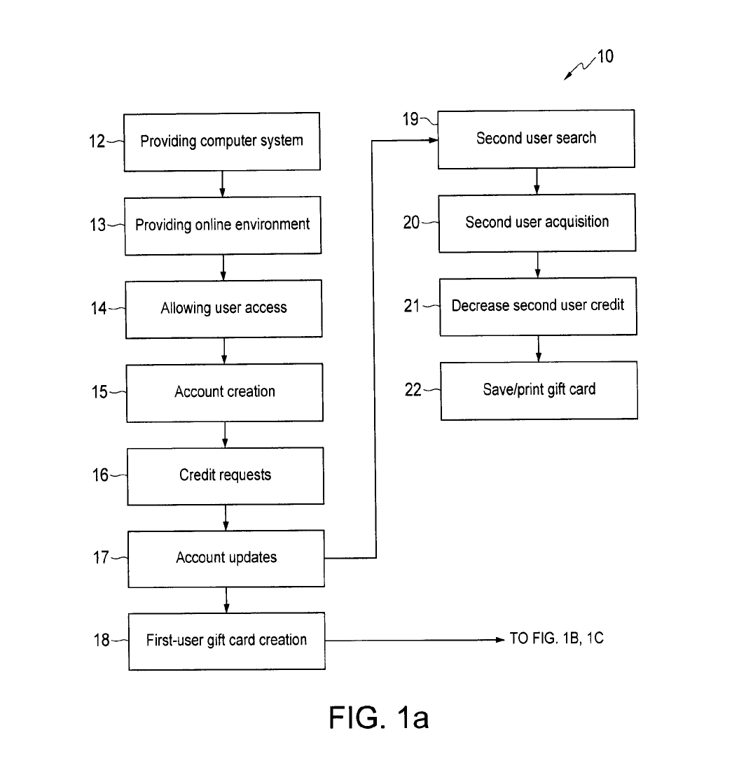

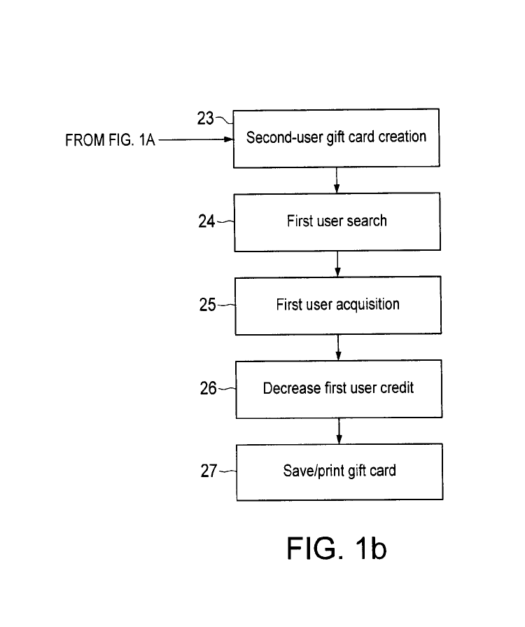

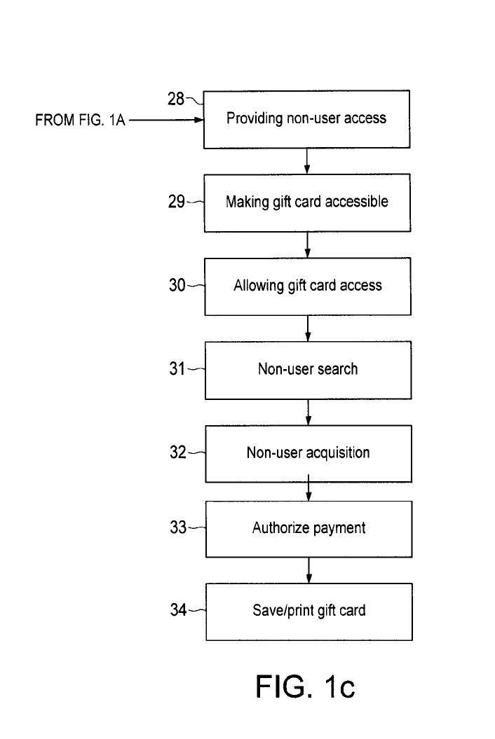

Referring now to FIGS. 1a, 1b and 1c, one exemplary embodiment of a method 10 according to the present invention is illustrated. Referring in detail to FIG. 1a, a computer system is provided at step 12, the computer system being connected to a communication network in order to enable the desired communications and transactions. At step 13 an online environment such as a website is provided through the communication network, accessible to users through a standard user interface such as a personal computer, and at step 14 users are allowed access to the online environment. Note that users will normally be merchants where business services are being exchanged, but it is within the scope of the present invention to have non-merchant users who have services to offer.

Users will then create accounts at step 15, which would include personal and business details and any other information commonly required for similar online business systems, as determined by the website owner/administrator. The users will then generate credit requests at step 16, which credit requests—if accepted by the website administrator—result in the updating of the user accounts at step 17 to reflect an approved credit level. It is this credit level that is at the heart of the present invention. The credit level is used to determine both the amount of services that will be offered to other users and the amount of services that can be acquired from other users.

The present invention is essentially intended to enable a barter system, where service providers such as merchants can offer their own services in exchange for the services of other merchants. At step 17, the level of that exchange is determined. Where, for example, a user requests credit of $1000 at step 16, this credit request would be considered and, if approved, the account would be updated at step 17 to reflect a $1000 credit. The user then does two things with this credit: the user offers services totalling $1000 and may also acquire the services of others up to a value of $1000. Another user would also have requested credit, at the same or a differing level, and their services will be made available for the first user to acquire.

The present invention arranges the service exchange in the form of virtual gift cards. It is to be understood, however, that other forms of value recognition documents are possible and intended to fall within the scope of the present invention, gift cards simply being a known and accepted form of services credit in the marketplace and therefore a preferable vehicle. Returning to FIG. 1a, the user who has received credit in the system will use the website at step 18 to create one or more virtual gift cards that have a specified face value. For example, where a user has credit of $1000, they could create 10 virtual gift cards at $100 each, or 100 gift cards at $10 each. Note that the user determines the amount of each gift card, introducing valuable flexibility to the system. These gift cards would be uploaded to the system and made available to other users. At step 19, a second user is allowed to search for and locate one of the gift cards created and uploaded by the first user, using a search interface of common structure and features. If the second user wishes to conclude the transaction, they would select and acquire the first user's gift card at step 20. This acquisition, as stated above, occurs through the expenditure of some or all of the credit level of the second user, and the second user's credit level would be reduced at step 21 by an amount equivalent to the face value of the acquired gift card. Once acquired, the second user at step 22 can then save the virtual gift card to their personal computing device or print it off for redemption with the first user's business.

FIG. 1b provides further steps of the exemplary embodiment of the method 10, in which the first user becomes an acquirer of services. The second user creates one or more gift cards at step 23 using the website and uploads them to the system. This creation and uploading step 23 occurs after the step 17 account updating, so the second user has a specified credit level that can be used in step 23. As with the first user, the second user can use their credit to create gift cards of any number and denomination so long as the total falls within the approved credit level. The first user then uses the online search interface at step 24 to locate the second user's gift card, and at step 25 they can acquire that gift card by exchanging some of their own credit level equivalent to the face value of the gift card. The first user's credit level decreases at step 26 in accordance with the acquisition, and the first user can save or print off the acquired gift card at step 27 for redemption.

For the sake of clarity, it should be stressed that a user creates gift cards for a total value equal to their credit level; the reduction of a user's credit level that occurs through acquisition of other user cards does not decrease the amount available to the user for creating their own cards. It is helpful to think of the credit level approval of step 17 as generating two discrete values pools: a card creation value pool and a card acquisition value pool. The user can expend value from the card acquisition pool in acquiring gift cards from other users without reducing the amount of services that the user offers through its own gift cards, and vice versa.

Referring now to FIG. 1c, further steps of the exemplary embodiment of the method 10 are presented. Unlike other online services exchange or barter systems, the present invention does not require the payment of membership or per-transaction fees. A website owner must still in most cases generate revenue, however, if for no other reason than to support the website operation. In the exemplary embodiment of the present invention, the website owner retains a certain percentage of the gift cards of the registered users, and subsequently offers those gift cards for sale to non-members at a discount to the face value. Given that the website owner paid nothing for the gift cards, even a discounted value for the retained cards generates positive revenue. For example, if a user had $1000 in credit and created 10 cards of $100 each, the website owner could retain one of those $100 gift cards and offer it for sale on the website at a discount of 30%; the website owner could then realize $70 in revenue while the purchaser of the discounted gift card would receive the value of $100 of services for a payment of only $70. These figures and percentages are exemplary only, and intended only for descriptive purposes.

Once the website owner/administrator has retained the gift card, they would need to provide non-member purchasers with access to the online environment in order to facilitate a purchase. This access could take any reasonable form, but it is preferable to maintain a single website and have a members-only, password-protected area for merchant-users and a separate publicly accessible area for potential gift card purchasers. In addition to the provision of website access to potential purchasers at step 28, the gift card will need to be located in an accessible area at step 29 to enable searching and selection; this can be achieved by creating a separate pool of gift cards comprising the retained gift cards only, not the gift cards that are available for exchange between the merchant-users. Potential purchasers can then be provided with access to the pool at step 30 and presented with a search interface at step 31 to enable the location and selection of a desired gift card. Unlike the merchant-users, non-member purchasers of retained gift cards do not have a credit level to use in the acquisition of a desired gift card at step 32, and the website would therefore require a means to receive and evaluate payment information, which can be in any manner known in the field of electronic commerce that is suitable for use with the present invention, as would be clear to one skilled in the art. Once payment is received and authorized at step 33, the purchaser can save or print off their purchased gift card at step 34 for later redemption.

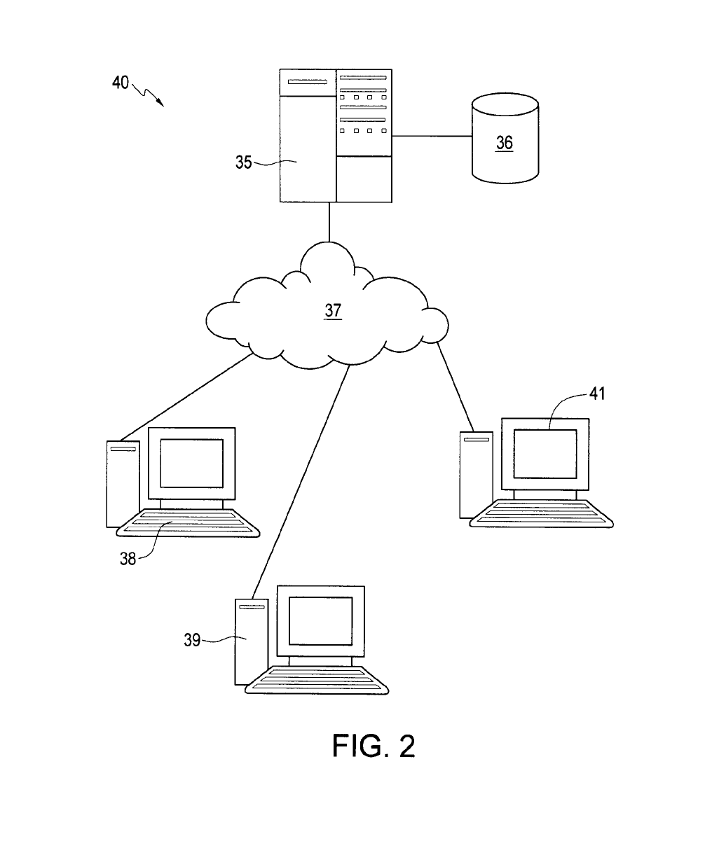

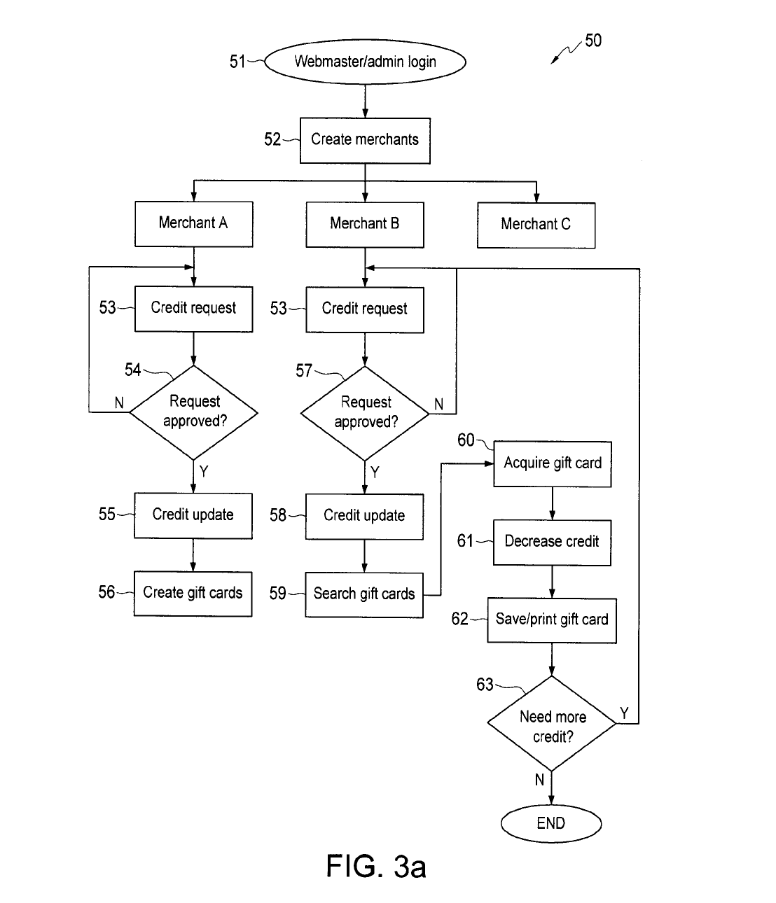

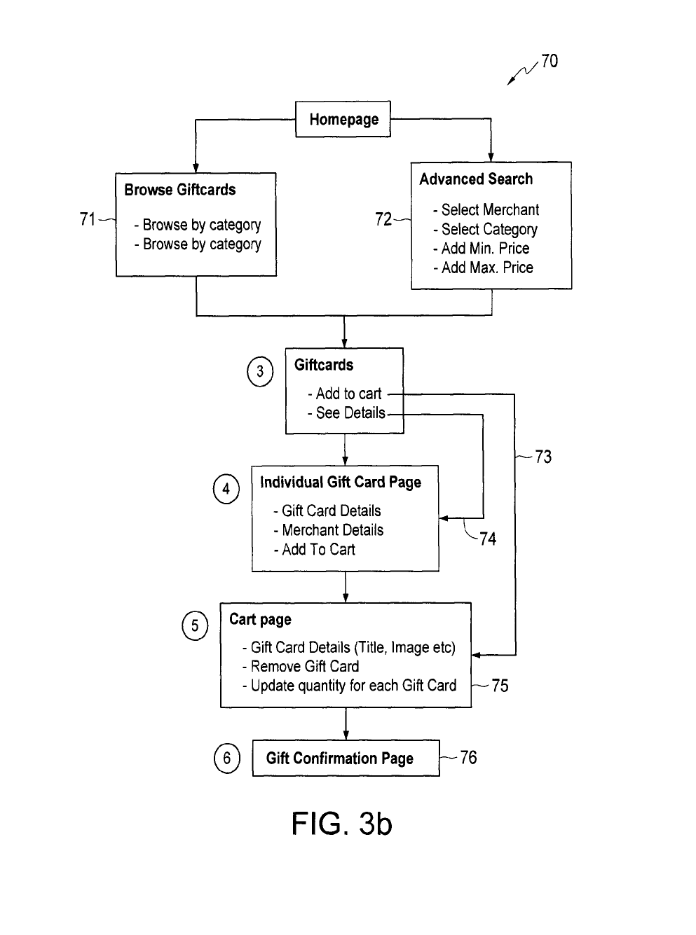

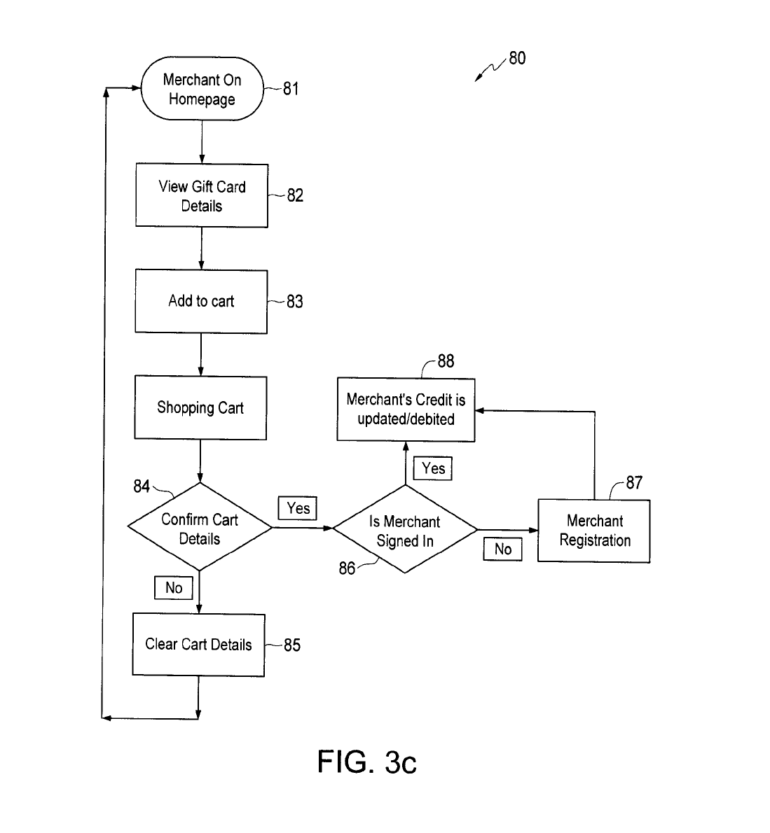

Turning now to FIGS. 3a, 3b and 3c, details of a merchant-based transaction method are illustrated. In FIG. 3a, which illustrates method 50, a webmaster or administrator logs into the system at step 51 and creates merchant profiles at step 52, resulting in accounts for Merchant A, Merchant B and Merchant C. Note that in this method 50 the webmaster/administrator creates the accounts based on user input, but this could simply be an automatic account approval upon specified input fields being adequately completed by a user. Once the accounts are created, Merchant A and Merchant B send credit requests at step 53 to the webmaster/administrator (through a web interface or electronic mail); where the request is denied, a further request will be necessary. Where the request of Merchant A is approved at step 54, Merchant A's credit is updated at step 55 and Merchant A can then create and upload virtual gift cards at step 56. Merchant B's credit request is approved at step 57 and their credit updated at step 58, and they can therefore search gift cards at step 59 and acquire a desired gift card at step 60. Merchant B's credit level is decreased at step 61 in accordance with the acquisition, and Merchant B can then save or print off their newly-acquired gift card. If Merchant B determines that they would like to acquire further gift cards but do not have sufficient remaining credit, they can decide at step 63 to make a further credit request; otherwise, the transaction is concluded.

FIG. 3b illustrates a method 70 incorporating greater detail around the gift card acquisition stage. In this method 70, the user can search for gift cards in one of two ways, either a simple browse function 71 or an advanced search 72. In the browse search 71, the user can search gift cards based on category (or subcategory), whereas in the advanced search 72 the user can search under merchant name, category, minimum price or maximum price. It should be noted that in either search option 71 or 72 the search criteria are selected as part of the website design and can vary from the exemplary embodiment. Once a desirable gift card has been located, it is either added to the user's cart at step 73 or the user may view details of the gift card at step 74 (including merchant details). Once selected and added to the user's cart, the user can go to a web page setting out details of all items added to the cart at step 75, which includes options such as removal of the gift card selection. Where the user decides that it wishes to conclude the transaction, it can continue to the gift card confirmation page at step 76.

FIG. 3c illustrates a method 80 which adds yet another detail for exemplary embodiments of the present invention. After the user has logged in at the homepage at step 81 and viewed details for the desired gift card at step 82, the gift card can be added to the cart at step 83. If cart details are not confirmed at step 84, the cart is cleared at step 85 and the user returns to the homepage. If the cart details are confirmed at step 84, there is a step 86 to confirm that the user is signed in before concluding the transaction; if the user is not signed in, sign-in occurs at step 87, the transaction concludes and the user's credit is decreased at step 88. This method 80 could be used in embodiments of the present invention where a user is able to access the gift card data without first logging in.

The above method description is intended to be exemplary only and not exhaustive of the means of implementing the method of the present invention. Given that the present invention employs an online environment, a skilled person would understand that there are many and diverse means of crafting a method in accordance with the present invention in light of the common knowledge in the art of web design and electronic commerce.

System

The present invention is also directed to a system for facilitating the method described above. It is believed that the determination of appropriate specific hardware for implementing the present invention is within the common general knowledge of one skilled in the art. Also, any software development necessary for implementation of the present invention, including website engineering, is considered to be within the common general knowledge of one skilled in the art of programming, not requiring any unusual effort or experimentation to generate beyond the disclosure herein. It is therefore believed that the below description is sufficiently enabling for one skilled in the relevant art, and few further details of exemplary hardware or software will be provided herein.

Referring now to FIG. 2, one exemplary embodiment of a system 40 according to the present invention is illustrated. The system 40 comprises a processor or server 35 configured to facilitate transactions pursuant to the present invention, the server 35 connected to a memory storage device or database 36 and a network 37 (which database 36 could be physically incorporated within the housing of the server 35 rather than a separate physical structure). The server 35 may be a Dell™ PowerEdge™ R710, but numerous other servers could be substituted as would be obvious to one skilled in the art. The central database 36 is configured to store various information used to facilitate services exchange transactions; for example, the database 36 could be configured to store information pertaining to users, accounts, gift cards and past transactions. The server 35 is connected to users 38, 39 and a non-user purchaser 41 by means of the network 37. Although the interfaces for the users 38, 39 and non-user purchaser 41 are represented by personal desktop computers, it is to be understood that other known computing devices could be employed, whether stationary or portable, and may employ any known communication means, including wired and wireless communication. A network presence such as a website on the Internet is the preferred access point for users and non-user purchasers using conventional browser software.

The term “computer” is used throughout and is intended to be a general reference to an electronic device comprising a processor, rather than to any specific computer type or configuration. It is understood that a computer is capable of receiving data, performing operations thereupon and generating results in the form of information or signals. Where the term “computer” is used in the singular, it is to be understood that this can, where appropriate in the context, include more than one computer linked by a communication network.

A system 40 in accordance with the present invention comprises a user interface 38, 39, a memory storage device 36 and a processor 35 coupled to the memory storage device 36 and in communication with the user interface 38, 39, the processor 35 being operative to facilitate a method in accordance with the present invention. The processor 35 incorporates a computer-readable medium containing statements and instructions for facilitating a method in accordance with the present invention. The system 40 for electronically exchanging services between a plurality of users comprises means for allowing the plurality of users to create accounts; means for receiving and approving credit requests from the plurality of users; means for allowing the plurality of users to create virtual gift cards; means for allowing a second user to search for and locate a first-user virtual gift card created by a first user having a first value; means for allowing the second user to select the first-user virtual gift card and acquire it by exchanging a first credit amount from the approved credit level of the second user equivalent to the first value; means for decreasing the approved credit level of the second user by the first credit amount; and means for allowing the second user to save or print the first-user virtual gift card.

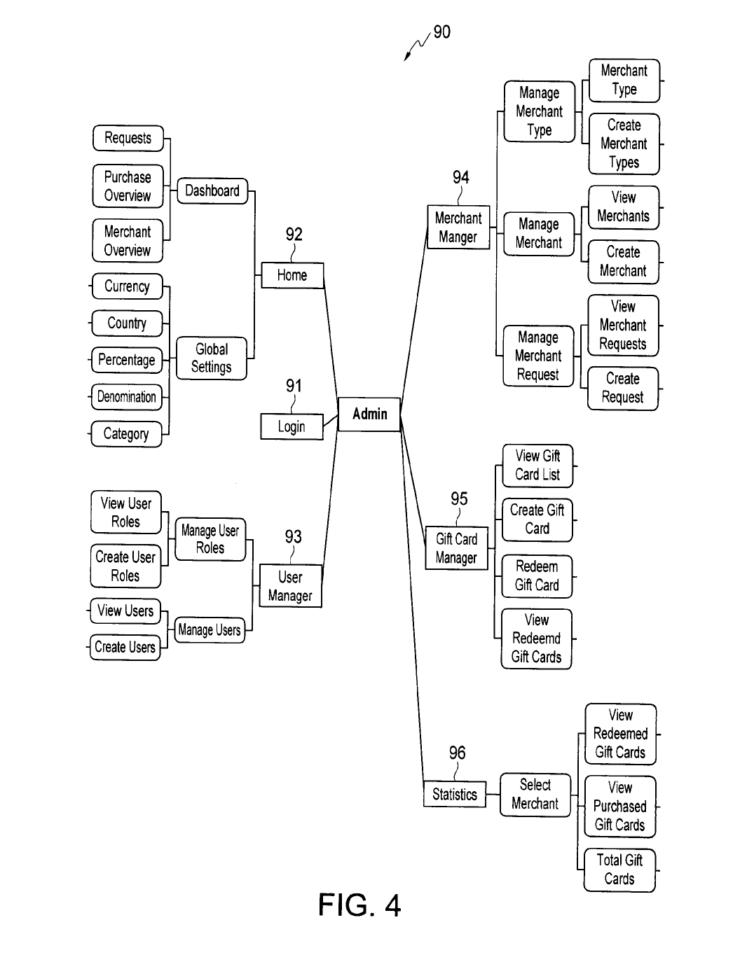

Referring now to FIG. 4, a website structure 90 is illustrated showing the various modules relevant to the roles and responsibilities of the webmaster/administrator. In this embodiment, the administrator has an enhanced role in making and executing requests on behalf of the merchant-users, but it is to be understood that other structures can be envisioned with greater merchant participation and are intended to be included within the scope of the present invention, as described further herein. The structure 90 includes a login module 91, a home module 92, a user manager module 93, a merchant manager module 94, a gift card manager module 95 and a statistics module 96. Note that the “user” manager module refers to sub-administrators who are delegated certain roles or tasks related to administration of the website and the system, not “users” as that term is employed herein with reference to merchants who exchange services through the method and system of the present invention. The webmaster/administrator can manage merchants and their requests, create and/or redeem gift cards for merchants, and access reports and statistics for acquired and purchased gift cards.

The login module 91 allows the administrator to log in to the system via a login ID and password. The administrator can change these details if required at any time, and can also recover the password from this module in case they forget the password.

The home module 92 includes a dashboard page to allow viewing of a summary of the system activity. For example, one can access credit requests in the form of a pie chart or in a tabular format, for requests made in the past and on the access date. The administrator can view a graph illustrating the purchase of gift cards during a set period of days along with a section showing gift cards purchased on the access date. A merchant overview section displays the number of requests made by a particular merchant through the website.

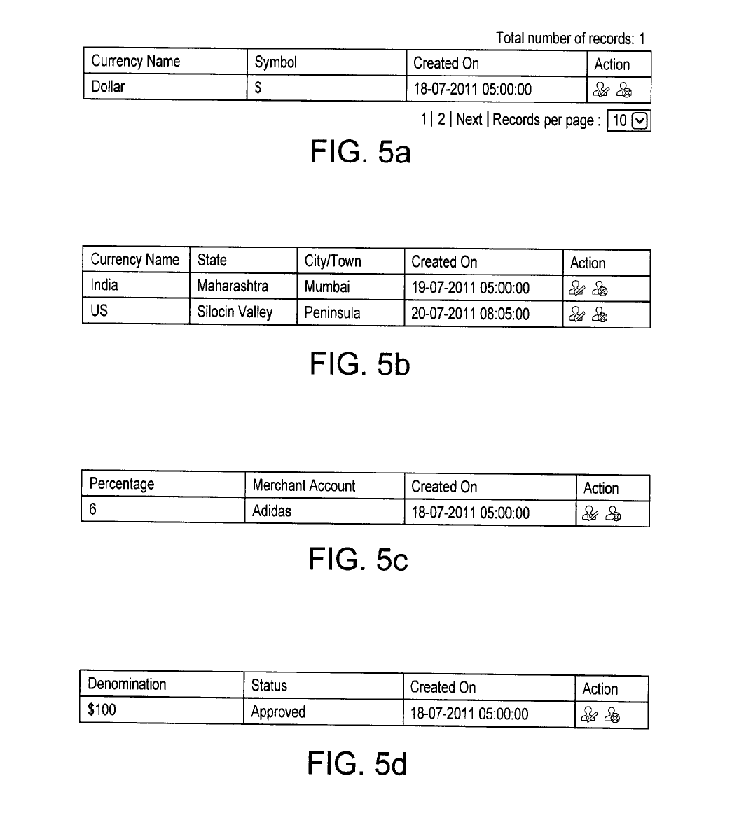

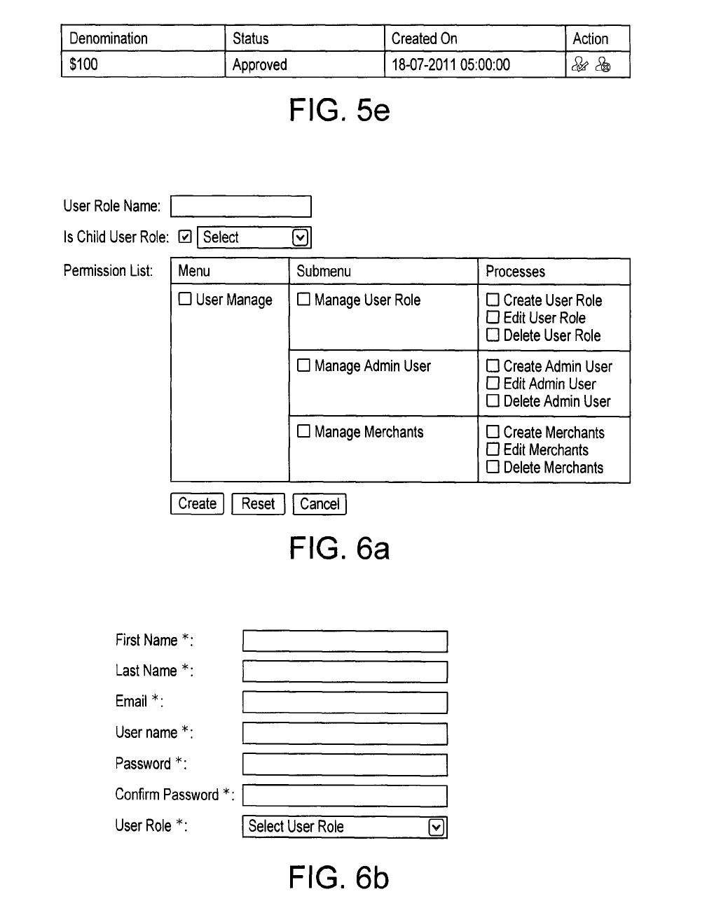

The home module 92 includes a global settings page, which allows the administrator to view and manage the content that will be reflected on all of the pages accessible by the administrator and merchant-users. The global settings page allows the administrator to add or delete currency names and symbols (see FIG. 5a), countries/cities for regional information relevant to services offerings (see FIG. 5b), percentage settings for each merchant-user (see FIG. 5c), denomination settings (see FIG. 5d), and categories (see FIG. 5e). Note that these screen shots are exemplary only, and different settings may be appropriate in different contexts. Additional settings may be desired by different administrators, and the web design would incorporate such modifications, as would be obvious to one skilled in the art.

The user manager module 93 is used to create sub-administrators and to delegate specific tasks or authority levels to them. The “Manage User Roles” page allows the administrator to search specified user roles and view user roles already created in the system, and these roles can be edited or deleted by the administrator. FIG. 6a illustrates a page for use in creating and assigning user roles. The “Manage Users” page allows the administrator to search for users and assigned roles, and edit or delete as desired; FIG. 6b illustrates an exemplary page for creating a user.

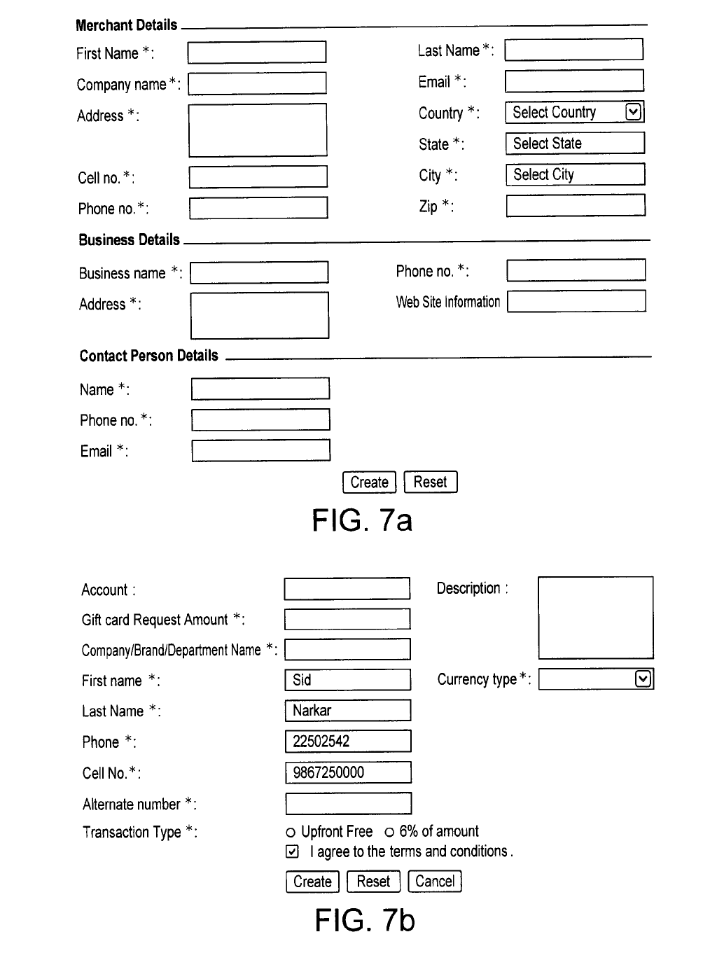

The merchant manager module 94 is used to create and manage merchant profiles. Using the “Manage Merchant Type” page, the administrator can create, manage and view merchant types. Using the “Manage Merchant” page, the administrator can create, manage and view profiles for specific merchants. FIG. 7a illustrates a merchant creation template. Using the “Manage Merchant Request” page, the administrator can view and manage merchant requests. FIG. 7b illustrates a template for creating a merchant request; depending on the chosen approach, either the merchant or the administrator would provide the necessary information and submit it for processing. The administrator can select either an up-front fee or a set percentage, although it is expected that most merchants will select participation on a percentage basis.

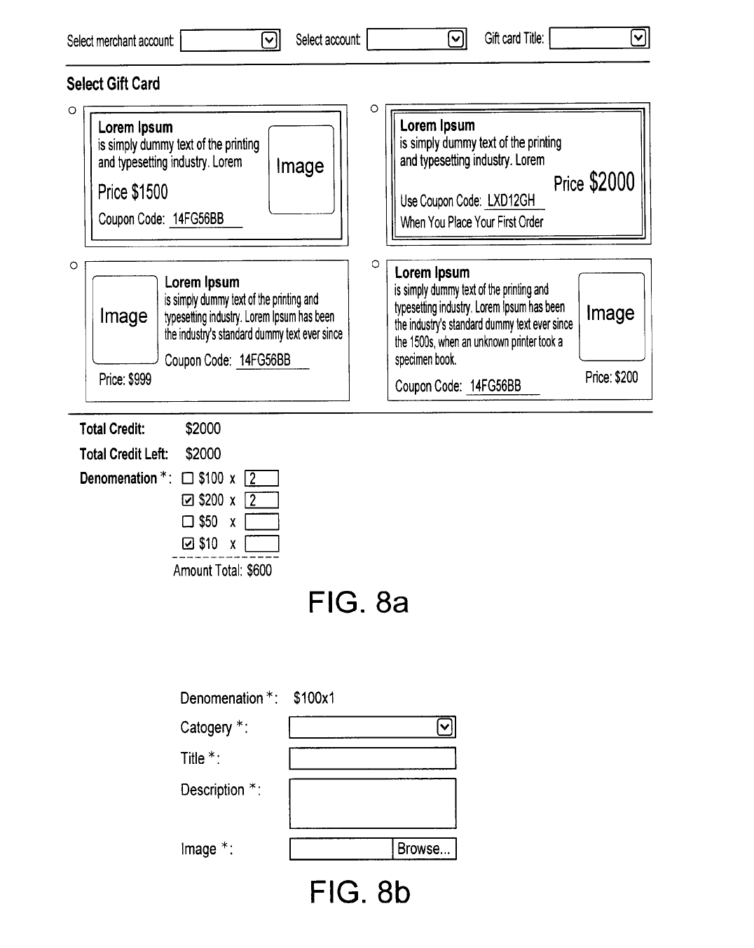

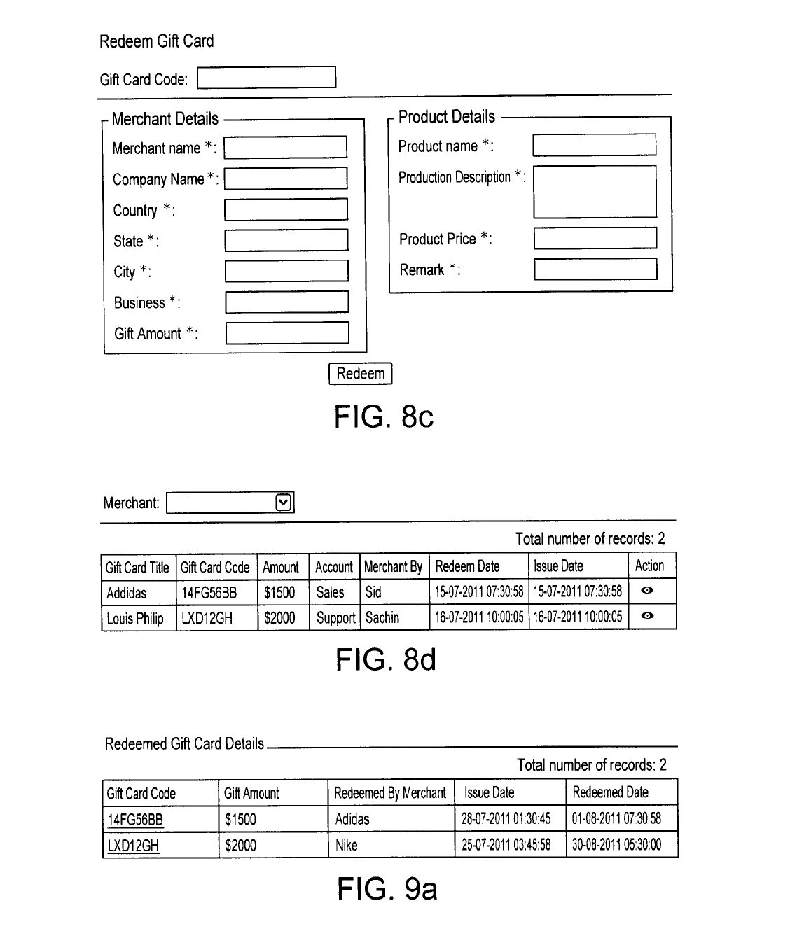

The gift card manager module 95 is used by the administrator to manage all gift cards created using the system, including the ability to edit, delete, view and print the gift cards. On the “Create Gift Cards” page, the administrator can create a gift card for a merchant-user and select a specific face value. Note that this function is normally undertaken by the merchant itself, but this page allows the administrator to do so where appropriate or required. FIG. 8a illustrates an exemplary gift card creation template, and FIG. 8b illustrates an interface for inserting certain gift card details. On the “Redeem Gift Card” page (see FIG. 8c), the administrator can redeem or acquire a gift card on behalf of a merchant-user upon request; alternatively, the merchant-user itself can generate this information. As can be seen in FIG. 8d, this page can also allow access to a summary report showing redeemed or acquired gift cards based on a filter such as merchant name.

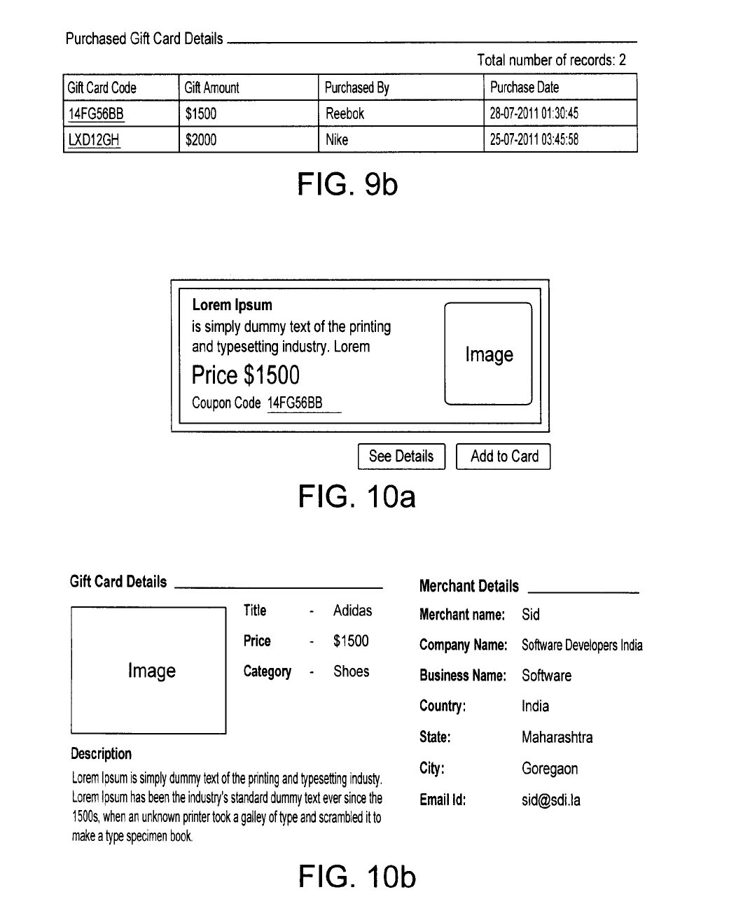

Finally, there is a statistics module 96 that allows an administrator to view statistics such as redeemed gift cards, purchased gift cards and total number of gift cards. FIGS. 9a and 9b illustrate examples of such reports.

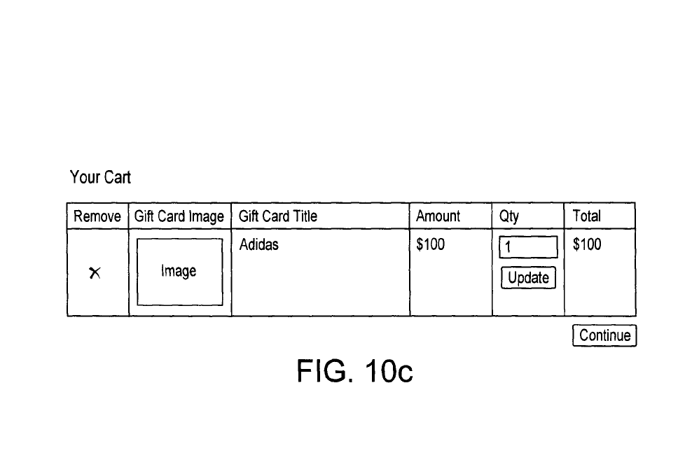

FIGS. 10a, 10b and 10c illustrate additional exemplary screen shots relating to the gift cards, with reference to the method of FIG. 3b. FIG. 10a shows one example of a virtual gift card as would be seen by a merchant conducting a search of other users' gift cards. FIG. 10b shows additional details accessible by a merchant-user in evaluating whether or not to acquire the gift card. Finally, FIG. 10c shows a merchant's cart with a gift card included, ready for confirmation and acquisition.

As can be readily seen, then, the method and system of the present invention present significant advantages over the prior art. First, it provides a highly flexible trading/barter system, where users can distribute their credit level amount in any number of gift cards and denominations. Second, there is no required membership fee or per-trans action fee, as the website owner can generate revenue by selling retained gift cards at a discount to face value to non-user purchasers. Third, merchant-users are provided with a means of obtaining advertising among other merchants and non-member consumers without any additional cost. Other advantages will be clear and obvious to anyone skilled in the art or familiar with prior art online barter systems.

The foregoing is considered as illustrative only of the principles of the invention. Thus, while certain aspects and embodiments of the invention have been described, these have been presented by way of example only and are not intended to limit the scope of the invention. Indeed, the invention described herein may be embodied in a variety of other forms without departing from the spirit of the invention, which invention is defined solely by the claims below.

1. A computer-implemented method for facilitating exchange of services between a plurality of users, the method comprising the steps of:
a. providing a computer system connected to a communication network;
b. providing an online environment accessible through a user interface of the computer system via the communication network;
c. allowing the plurality of users to access the online environment;
d. allowing first and second users of the plurality of users to create accounts in the online environment;
e. receiving a credit request from each of the first and second users;
f. updating the accounts to reflect an approved credit level for each of the first and second users;
g. allowing the first user to create and upload to the online environment at least one first-user virtual value recognition document for services to be provided by the first user, the at least one first-user virtual value recognition document being assigned a first value equal to or less than the approved credit level of the first user;
h. allowing the second user to search for and locate the at least one first-user virtual value recognition document;
i. allowing the second user to select the at least one first-user virtual value recognition document and acquire it by exchanging a first credit amount from the approved credit level of the second user equivalent to the first value;
j. decreasing the approved credit level of the second user by the first credit amount; and
k. allowing the second user to save or print the at least one first-user virtual value recognition document.

2. The computer-implemented method of claim 1 comprising the following additional steps after step f:
allowing the second user to create and upload to the online environment at least one second-user virtual value recognition document for services to be provided by the second user, the at least one second-user virtual value recognition document being assigned a second value equal to or less than the approved credit level of the second user;
allowing the first user to search for and locate the at least one second-user virtual value recognition document;
allowing the first user to select the at least one second-user virtual value recognition document and acquire it by exchanging a second credit amount from the approved credit level of the first user equivalent to the second value;
decreasing the approved credit level of the first user by the second credit amount; and
allowing the first user to save or print the at least one second-user virtual value recognition document.

3. The computer-implemented method of claim 1 wherein the first user creates and uploads to the online environment at least two first-user virtual value recognition documents, comprising the following additional steps after step g:
providing an area of the online environment accessible by non-user outside consumers;
locating one of the at least two first-user virtual value recognition documents in the area of the online environment accessible by non-user outside consumers;
allowing a non-user outside consumer to access the online environment;
allowing the non-user outside consumer to search for and locate the one of the at least two first-user virtual value recognition documents;
allowing the non-user outside consumer to select the one of the at least two first-user virtual value recognition documents and acquire it at a discount to the first value by providing payment information;
authorizing the payment information; and
allowing the non-user outside consumer to save or print the one of the at least two first-user virtual value recognition documents.

4-6. (canceled)

7. A computer-readable medium containing statements and instructions for facilitating exchange of services between a plurality of users, the computer-readable medium for installation within a computer system connected to a communication network, the computer system comprising a user interface providing access to an online environment through the communication network, the statements and instructions, when executed, causing the computer to perform a method comprising the steps of:
a. allowing the plurality of users to access the online environment;
b. allowing first and second users of the plurality of users to create accounts in the online environment;
c. receiving a credit request from each of the first and second users;
d. updating the accounts to reflect an approved credit level for each of the first and second users;
e. allowing the first user to create and upload to the online environment at least one first-user virtual value recognition document for services to be provided by the first user, the at least one first-user virtual value recognition document being assigned a first value equal to or less than the approved credit level of the first user;
f. allowing the second user to search for and locate the at least one first-user virtual value recognition document;
g. allowing the second user to select the at least one first-user virtual value recognition document and acquire it by exchanging a first credit amount from the approved credit level of the second user equivalent to the first value;
h. decreasing the approved credit level of the second user by the first credit amount; and
i. allowing the second user to save or print the at least one first-user virtual value recognition document.

8. The computer-readable medium of claim 7 wherein the statements and instructions, when executed, cause the computer to perform the following additional steps after step d:
allowing the second user to create and upload to the online environment at least one second-user virtual value recognition document for services to be provided by the second user, the at least one second-user virtual value recognition document being assigned a second value equal to or less than the approved credit level of the second user;
allowing the first user to search for and locate the at least one second-user virtual value recognition document;
allowing the first user to select the at least one second-user virtual value recognition document and acquire it by exchanging a second credit amount from the approved credit level of the first user equivalent to the second value;
decreasing the approved credit level of the first user by the second credit amount; and
allowing the first user to save or print the at least one second-user virtual value recognition document.

9. The computer-readable medium of claim 7 wherein the first user creates and uploads to the online environment at least two first-user virtual value recognition documents, wherein the statements and instructions, when executed, cause the computer to perform the following additional steps after step e:
providing an area of the online environment accessible by non-user outside consumers;
locating one of the at least two first-user virtual value recognition documents in the area of the online environment accessible by non-user outside consumers;
allowing a non-user outside consumer to access the online environment;
allowing the non-user outside consumer to search for and locate the one of the at least two first-user virtual value recognition documents;
allowing the non-user outside consumer to select the one of the at least two first-user virtual value recognition documents and acquire it at a discount to the first value by providing payment information;
authorizing the payment information; and
allowing the non-user outside consumer to save or print the one of the at least two first-user virtual value recognition documents.

10. A computer-implemented system for online networking based on exchange of business services between a plurality of users, comprising:
a user interface;
a memory storage device;
a processor coupled to the memory storage device and in communication with the user interface, the processor being operative to:
a. allow first and second users of the plurality of users to create accounts in a networked environment through the user interface;
b. save the accounts on the memory storage device;
c. receive a credit request from each of the first and second users through the user interface;
d. update the accounts to reflect an approved credit level for each of the first and second users;
e. allow the first user through the user interface to create at least one first-user virtual value recognition document for services to be provided by the first user, the at least one first-user virtual value recognition document being assigned a first value equal to or less than the approved credit level of the first user;
f. save the at least one first-user virtual value recognition document on the memory storage device;
g. allow the second user to search for and locate the at least one first-user virtual value recognition document through the user interface;
h. allow the second user through the user interface to select the at least one first-user virtual value recognition document and acquire it by exchanging a first credit amount from the approved credit level of the second user equivalent to the first value;
i. decrease the approved credit level of the second user by the first credit amount; and
j. allow the second user to save or print the at least one first-user virtual value recognition document.

11. The computer-implemented system of claim 10 wherein the processor is further operative to execute the following after step d:
allow the second user through the user interface to create at least one second-user virtual value recognition document for services to be provided by the second user, the at least one second-user virtual value recognition document being assigned a second value equal to or less than the approved credit level of the second user;
save the at least one second-user virtual value recognition document on the memory storage device;
allow the first user to search for and locate the at least one second-user virtual value recognition document through the user interface;
allow the first user through the user interface to select the at least one second-user virtual value recognition document and acquire it by exchanging a second credit amount from the approved credit level of the first user equivalent to the second value;
decrease the approved credit level of the first user by the second credit amount; and
allow the first user to save or print the at least one second-user virtual value recognition document.

12. The computer-implemented system of claim 10 further comprising a non-user outside consumer interface, wherein the first user creates at least two first-user virtual value recognition documents and wherein the processor is further operative to:
provide an area accessible by non-user outside consumers;
locate one of the at least two first-user virtual value recognition documents in the area accessible by non-user outside consumers;
allow a non-user outside consumer to access the area through the non-user outside consumer interface;
allow the non-user outside consumer to search for and locate the one of the at least two first-user virtual value recognition documents through the non-user outside consumer interface;
allow the non-user outside consumer to select the one of the at least two first-user virtual value recognition documents and acquire it at a discount to the first value by providing payment information;
authorize the payment information; and
allow the non-user outside consumer to save or print the one of the at least two first-user virtual value recognition documents.

13-27. (canceled)
